(19) United States
(12) Patent Application Publication
(10) Pub. No.: US 2013/0198692 A1
(43) Pub. Date: Aug. 1, 2013

(54) SYSTEMS AND METHODS FOR MANAGING PRESENTATIONS OF OPEN DOCUMENTS

(71) Applicant: Andrew Lin, San Francisco, CA (US)

(72) Inventor: Andrew Lin, San Francisco, CA (US)

(73) Assignee: Adobe Systems Incorporated, San Jose, CA (US)

(21) Appl. No.: 11/936,675

(22) Filed: Nov. 7, 2007

(51) Int. Cl. G06F 3/048

(52) U.S. Cl. 715/835

(57) ABSTRACT

Systems and methods for managing presentation of open documents, wherein a software application presents a user interface that provides a plurality of user-selectable elements (such as tabs) that each corresponds to a respective one of a plurality of open documents. The user interface enables selection of a plurality of the elements concurrently, and in response to such concurrent selection of a plurality of the elements, the software application concurrently displays the respective plurality of documents to which the selected elements correspond.

### TECHNICAL FIELD

The following description relates generally to management of presentation of open documents in a software application; and more specifically to systems and methods in which a user interface provides a plurality of user-selectable elements (such as tabs) that each corresponds to a respective one of a plurality of open documents, wherein the user interface enables selection of a plurality of the elements concurrently, and in response to such concurrent selection a software application concurrently displays the respective plurality of documents to which the selected elements correspond.

### BACKGROUND OF THE INVENTION

Users of software applications commonly work with several open documents concurrently within such application(s). The open documents may be separate files, and/or may provide different views or different content of a common file. As one example, a user may open various image files in an image editing application, such as ADOBE® PHOTOSHOP®, ADOBE® FIREWORKS®, COREL® PAINTER, COREL® PAINTSHOP PRO, COREL® PHOTO-PAINT, MICROSOFT® DIGITAL IMAGE, MICROSOFT® PAINT, etc. As another example, a user may open various documents in a word processing application, such as MICROSOFT® WORD®, MICROSOFT® WORDPERFECT®, MICROSOFT® WORKS, IBM® LOTUS® WORD PRO, etc. As another example, a software application authoring tool may enable a user to open various documents related to an application under development, such as a textual code document, one or more referenced documents that are referenced in the code document, a design-view document, etc. Many software application authoring tools are available today for use by software developers in creating various types of software applications, including as examples ADOBE® DREAMWEAVER® and MICROSOFT® FRONTFPAGE®.

Difficulty often arises in managing presentation of various open documents. How the user desires to manage the presentation of the open documents may depend on the type of work that the user is performing on the documents. For instance, if a user is desiring to work in only one document at a time, the user may desire to have only one document at a time presented to the user (e.g., so as to maximize the amount of display area used for presenting the document with which the user is working at a given time). On the other hand, if the user is working in multiple documents concurrently, such as comparing two or more documents, etc., the user may desire to have the multiple documents presented concurrently on the display (e.g., arranged side-by-side on the display). Thus, the way in which the presentation of documents is to be managed may vary with the user's desires, e.g., based on how the user is working with the open documents at a given time.

Traditionally, applications have provided users with various options for managing the presentation of open documents. As one option, certain applications provide a floating-window view of open documents, wherein each open document is presented in a separate window that is floating on the display (or within a containing window of the application in which such document is opened). As another option, certain applications provide a tabbed-interface view in which a separate tab is presented for each of the open documents, and a user may select any one of the tabs to cause the corresponding one of the open documents to be displayed. Each of these traditional presentation management techniques is described further below.

First, certain applications offer a floating window view of open documents, in which open documents are presented in separate windows. For instance, a first open document may be presented in a first window, a second open document may be presented in a second window, etc. Such windows may be “floating” on the display (or within a containing window), and the user may manually arrange the windows in a desired manner on the display (or within the containing window). For instance, the user may size the windows as desired, and position the windows to a desired location on the display.

FIG. 1A shows an example of such floating windows of the prior art. A display 10 is shown, which may be a full display screen or a containing window of an application, as examples. Within such display 10, a plurality of windows 101, 102, and 103 are shown, each of which contains content corresponding to a respective one of a plurality of documents that are open in an application. For instance, window 101 contains content 104 of a first document “doc. 1”, window 102 contains content 105 of a second document “doc. 2”, and window 103 contains content 106 of a third document “doc. 3”. The content of the documents may comprise text, graphics (e.g., images), and/or any other content suitable for the corresponding application in which the document is opened. As is well-known, a user may manually interact with the windows 101-103 to re-size them and position them on display 10 in a desired manner. Such manual management of the floating windows often becomes undesirably inefficient and time-consuming. Further, a user may effectively lose a window on the display when such window is covered by other windows, and thus the user may have difficulty keeping track of the documents that he/she has open within the application.

Further, some applications offer certain types of automated assistance for managing the presentation of open documents, such as automatic tiling, cascading, etc. of windows. For instance, applications such as MICROSOFT® WORD® provide a “Window” menu item, which when selected presents the user with a list of documents that are open in the application, wherein the user can select from the menu list any one of the open documents to be presented on the display. Additionally, such application may offer a menu selection to “split” a given document that is being presented on the display into two windows that are concurrently displayed and are separately navigable to display different parts of the given document. For instance, for a lengthy word processing document, a user may select a split view in which a first portion of the document (e.g., the beginning of the document) is displayed in a first window and a second portion of the document (e.g., the ending of the document) is displayed in a second window, wherein the windows are displayed concurrently (e.g., in a stacked fashion with one arranged on above of the other).

Further, some applications may also offer a menu selection to automatically arrange windows of the various open documents. For example, the application may offer a menu selection to “cascade” the windows of the open documents, wherein the windows of all of the open documents are automatically staggered across the display in a cascaded fashion such that only a small portion (e.g., the title bar) of each underlying window may be seen and all of the top window of the cascade can be seen. As another example, the application may offer a menu selection to “tile horizontally,” wherein windows of all of the open documents are automatically shrunk and concurrently presented in an arrangement of one window above the other on the display (i.e., the windows are wide and short such that they each span across the width of the display 10 and are arranged adjacent each other from the top of the display to the bottom of the display). As another example, the application may offer a menu selection to “tile vertically,” wherein windows of all of the open documents are automatically shrunk and concurrently presented in a side-by-side arrangement on the display (i.e., the windows are tall and narrow such that they each span from the top to the bottom of the display 10 and are arranged adjacent each other from the left side of the display to the right side of the display).

It should be noted that the above-mentioned assistance techniques do not provide an immediately-accessible aid for tracking the documents that are open in the application. Rather, any such listing of open documents is embedded within a menu (e.g., under the “Window” menu item). Further, the automatic arrangement operations mentioned above are performed for all of the open documents, and thus do not assist a user in arranging, only a select plurality of the open documents in the event that the user desires to concurrently view fewer than all of the open documents.

As an alternative to the above-mentioned floating-window document management technique, certain applications provide a tabbed-interface for managing the display of open documents. Such a tabbed-interface presents an immediately-accessible tab for each open document. That is, rather than being embedded within a menu, such tabbed-interface displays immediately-accessible tabs on which a user may click to select a corresponding open document to be displayed. Traditional tabbed-interfaces have offered mutually-exclusive selection capability, wherein a user may select any one tab of the tabbed-interface at a time in order to display the corresponding document. In this way, the traditional tabbed-interfaces are similar in function to the list of open documents that may be presented under a “Window” menu item (as mentioned above) in that a user can select any one (and only one) of the open documents to be displayed, but such tabbed-interfaces provide immediately accessible tabs that are not embedded in a menu. Some applications, such as DREAMWEAVER®, offer the user an ability to select either a floating-window view of open documents (such as that of FIG. 1A) or a tabbed-interface view of open documents (such as that of FIG. 1B discussed below).

FIG. 1B shows an example of such a tabbed-interface of the prior art. A display 10 is again shown, which may be a full display screen or a containing window of an application, as examples. Within such display 10, a tabbed-interface 120 is presented that includes an immediately-accessible tab for each open document. In this example, four documents, “Doc. 1”, “Doc. 2”, “Doc. 3”, and “Doc. 4” are open in the application, and thus four corresponding tabs 121, 122, 123, and 124 are presented in the tabbed-interface 120. Such a traditional tabbed-interface 120 illustrates the tabs as being mutually exclusive, wherein a user may select any one of the tabs 121-124 at a time for displaying the corresponding document. In the illustrated example, tab 123 is shown as selected, and thus content 125 of the corresponding document “Doc. 3” is presented on display 10.

Such traditional tabbed-interface view of open documents aids a user in keeping track of the documents currently open in an application (e.g., via the immediately accessible tabs), and makes it easy for the user to present any one of the open documents that is desired to be viewed at a given time (e.g., by selecting the corresponding tab). However, such traditional tabbed-interfaces have provided mutually-exclusive selection capability, such that a user is unable to use such tabbed-interface for selecting multiple ones of open documents to be presented concurrently.

A desire exists for an improved technique for aiding users in managing presentation of open documents.

### BRIEF SUMMARY OF THE INVENTION

The present invention is directed generally to systems and methods for managing presentation of open documents. According to certain embodiments of the present invention, a software application presents a user interface that provides a plurality of user-selectable elements (such as tabs) that each corresponds to a respective one of a plurality of open documents. The user interface enables selection of a plurality of the elements concurrently, and in response to such concurrent selection of a plurality of the elements, the software application concurrently displays the respective plurality of documents to which the selected elements correspond.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1A shows an example of floating windows of the prior art;

FIG. 1B shows an example of a tabbed-interface of the prior art;

FIG. 2 shows an exemplary interface for managing presentation of open documents according to one embodiment of the present invention;

FIG. 3 shows an exemplary operational flow of a software application for managing presentation of opened documents according to one embodiment of the present invention;

FIGS. 4A-4D show exemplary arrangements of concurrently selected documents on a display that may be determined by the software application according to an embodiments of the present invention;

FIG. 5 shows an example of identifying information being presented for the concurrently displayed windows according to one embodiment of the present invention;

FIG. 6 shows an exemplary user interface according to one embodiment of the present invention;

FIGS. 7A-7B shows another exemplary user interface according to an embodiments of the present invention; and

FIG. 8 shows an exemplary system on which a software application may be implemented according to one embodiment of the present invention

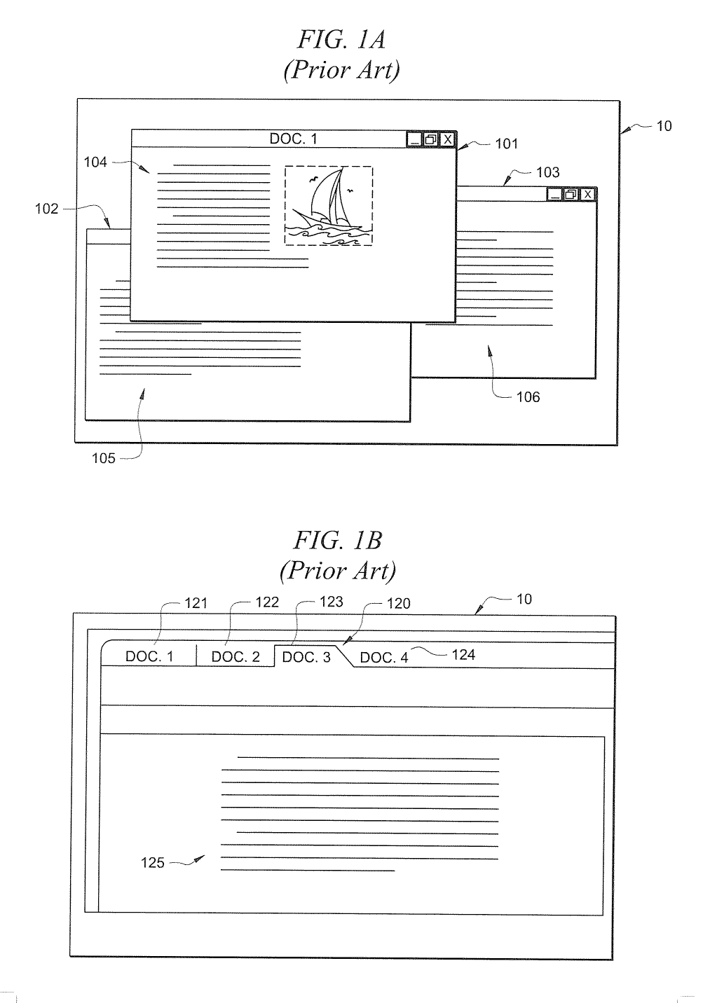

### DETAILED DESCRIPTION OF THE INVENTION

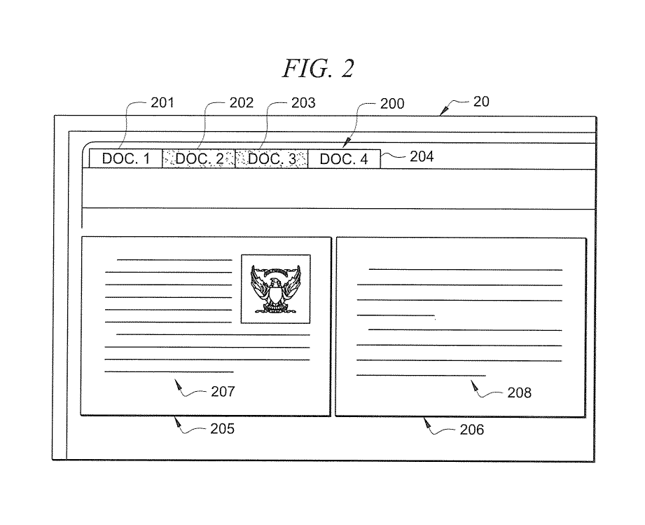

FIG. 2 shows an exemplary interface for managing presentation of open documents according to one embodiment of the present invention. A display 20 is shown, which may be a full display screen or a containing window of an application, as examples. Within such display 20, a software application presents a user interface 200 that provides a plurality of user-selectable elements, such as elements 201, 202, 203, and 204, that each corresponds to a respective one of a plurality of open documents. In this example, the user-selectable elements 201-204 are shown as tabs, and thus user interface 200 provides a tabbed-interface in this example. However, as discussed further below, interface 200 enables multiple ones of the tabs 201-204 to be selected concurrently, as opposed to traditional tabbed-interfaces mentioned above which require mutually-exclusive selection of each tab.

In the example of FIG. 2, interface 200 is presented that includes an immediately-accessible element (e.g., tab) for each open document. In this example, four documents, “Doc. 1”, “Doc. 2”, “Doc. 3”, and “Doc. 4”, are open in the application, and thus four corresponding elements 201, 202, 203, and 204, are presented in the interface 200. According to certain embodiments, user interface 200 enables selection of a plurality of the elements 201-204 concurrently, and in response to such concurrent selection of a plurality of the elements 201-204, the software application concurrently displays on display 20 the respective plurality of documents to which the selected elements 201-204 correspond.

Display 20 may be a soft display (e.g., a containing window of a software application that is presented on a display device, such as a monitor) or it may be all or a portion of a screen of a display device, such as a monitor. In either case, the display 20 may be part of a system that comprises a processor-based computer, such as a personal computer (PC), laptop computer, server computer, workstation computer, etc. Interface 200 may be provided by a software application that is executing on such a computer. The software application comprises computer-executable software code stored to a computer-readable medium that is readable by a processor of the computer and, when executed by such processor, causes the computer to perform the various operations described further herein, such as presenting the interface 200, enabling concurrent selection of a plurality of display elements 201-204, and displaying the corresponding documents to display 20. Such software application for presenting user interface 200 may, in certain embodiments, be part of larger overall software application. For example, the software application for presenting user interface 200 may be included as part of a software application in which the documents to which the elements 201-204 of the interface 200 correspond are opened, such as an image editing application (such as ADOBE® PHOTOSHOP®, ADOBE® FIREWORKS®, COREL® PAINTER, COREL® PAINTSHOP PRO, COREL® PHOTO-PAINT, MICROSOFT® DIGITAL IMAGE, MICROSOFT® PAINT, etc.), a word processing application (such as MICROSOFT® WORD®, MICROSOFT® WORDPERFECT®, MICROSOFT® WORKS, IBM® LOTUS® WORD PRO, etc.), or a software application authoring tool (such as ADOBE® DREAMWEAVER® and MICROSOFT® FRONTPAGE®), as examples.

In the illustrated example of FIG. 2, elements 202 and 203 corresponding to open documents Doc. 2 and Doc. 3, respectively, are concurrently selected, as indicated by the shading of elements 202 and 203 in the example of FIG. 2. A plurality of elements may be selected concurrently using any appropriate selection technique. As one example, many applications permit a plurality of items in a list to be selected by a user holding down one key of a keyboard with clicking the plurality of items to be selected with a mouse (or otherwise inputting a selection of the desired items, such as by using other navigation/selection keys of the keyboard), and any such techniques for concurrently selecting a plurality of items may be likewise employed by interface 200 for enabling a user to concurrently select a plurality of elements 201-204. In this way, the selection techniques for concurrently selecting a plurality of the elements 201-204 may be consistent with the concurrent selection technique commonly used for selecting a plurality of items in lists and may thus be readily recognizable by a user. As a specific example, in one embodiment a user may select a plurality of elements concurrently by holding down the “shift” key on a keyboard and selecting (e.g., by clicking with a pointing device, such as a mouse) a contiguous range of elements to be selected. As another example, in one embodiment a user may select a plurality of elements concurrently by holding down the “control” key on a keyboard and selecting (e.g., by clicking with a pointing device, such as a mouse) individual elements desired to be selected (which may or may not be a contiguous range of elements). It should be recognized that when referring to the elements being concurrently selected herein, the user may perform sequential actions (e.g., clicking on each element to be selected while holding down “control”), but such actions result in a plurality of the elements being selected concurrently (i.e., the user's actions result in the plurality of the selected elements being selected together, concurrently).

In response to the concurrent selection of elements 202 and 203 in the example of FIG. 2, the software application concurrently displays on display 20 the respective plurality of documents to which the selected elements 202-203 correspond, i.e., documents Doc. 2 and Doc. 3 in this example. Accordingly, in the illustrated example, the software application presents windows 205 and 206, wherein content 207 of document Doc. 2 is presented in window 205 and content 208 of document Doc. 3 is presented in window 206. Such “windows” 205 and 206 may be floating windows that the software application automatically arranges in some arrangement on the display 20 (e.g., in a side-by-side arrangement, such as illustrated in the example of FIG. 2), wherein the user may interact with such floating windows to rearrange them if so desired (e.g., as with management of traditional floating windows mentioned herein above). Alternatively, in certain embodiments the “windows” 205 and 206 may be fixed windows that are not floating on display 20, which the software application automatically arranges in some arrangement on the display 20 (e.g., in a side-by-side arrangement, such as illustrated in the example of FIG. 2).

Additionally, it should be recognized that the content of the documents may comprise text, graphics (e.g., images), and/or any other content suitable for the corresponding application in which the document is opened. Further, the content of each open document may comprise content of separate files in certain embodiments (e.g., separate image files, word processing files, etc.), while in other embodiments such content of different open documents may comprise content that pertains to a common file. For instance, certain software application authoring tools, such as ADOBE® DREAMWEAVER®, enable a user to open a textual code document view in which the textual code (e.g., HTML code, etc.) of an application is presented, and the user may also open a design-view (or “display-view”) document that shows a What You See Is What You Get (WYSIWYG) view of the document (e.g., a view of a resulting web page that would be produced by a browser when reading the textual code shown in the textual code document view). The design-view document allows the user to visually manipulate the interpreted and graphically laid-out version of the document, such as, for example, by dragging, dropping, cutting, and pasting visual components. As the developer works, changes to the document are reflected in both the code view and the design view. Additionally, other documents, such as referenced documents that are referenced in the code document (e.g., image files, etc.), may also be opened in the software application development tool. Thus, in certain embodiments, the plurality of open documents may comprise any of the various types of documents that may be opened in a given application, such as the exemplary types mentioned above.

In certain embodiments, the interface 200 enables “break-away” capability of its individual elements 201-204, whereby a user may click a given element (or plurality of elements) and drag such selected element(s) to a location on display 20 whereat the corresponding document(s) are then presented in free-floating windows. Of course, in certain embodiments, such break-away feature may be unnecessary as the interface 200 enables concurrent selection of a plurality of tabs and in response to such concurrent selection (without dragging or otherwise “breaking-away” the tab from the interface 200) present the corresponding documents concurrently (which may be presented in concurrently displayed free-floating windows in certain embodiments).

While tabs are shown in the illustrated example of FIG. 2, other user-interface elements may be presented in other embodiments. For instance, a textual list presenting textual items that each corresponds to one of the opened documents may be presented in certain embodiments. As another example, a grid of thumbnails or other graphical element may be presented for each of the open documents. Further, while interface 200 presents immediately-accessible elements 201-204 in the example of FIG. 2, in other embodiments, the elements may not be immediately accessible, but may instead be embedded in a menu (e.g., in a pull-down menu from the title bar, presented responsive to a right-click from the user or other user input, etc.). Additionally, while four display elements 201-204 are presented in the illustrated example of FIG. 2 as corresponding to four open documents, embodiments of the present invention are not restricted to any number of open documents and/or corresponding display elements that may be presented. Rather, any number of documents may be opened at a given time, and thus a corresponding number of display elements may be presented at such given time.

Further, while two documents are shown as being concurrently selected in the example of FIG. 2, any number of open documents may be concurrently selected in accordance with embodiments of the present invention. And, while two adjacent elements 202 and 203 are selected in the example of FIG. 2 (i.e., a contiguous range of elements 202-203 are selected), embodiments of the present invention may enable concurrent selection of non-adjacent elements (i.e., elements that are not contiguous the presented range of elements), as discussed further herein. As an example, in certain embodiments a user may concurrently select non-adjacent elements 201 and 203 for causing corresponding documents Doc. 1 and Doc. 3 to be concurrently displayed on display 20.

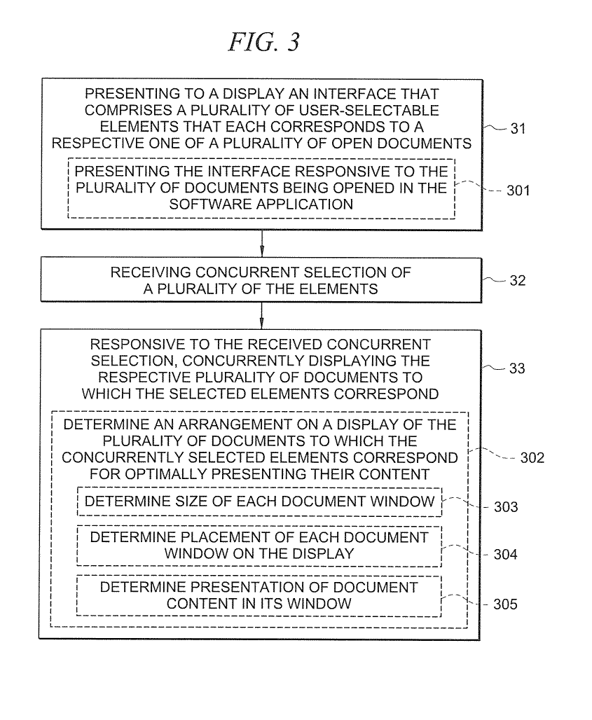

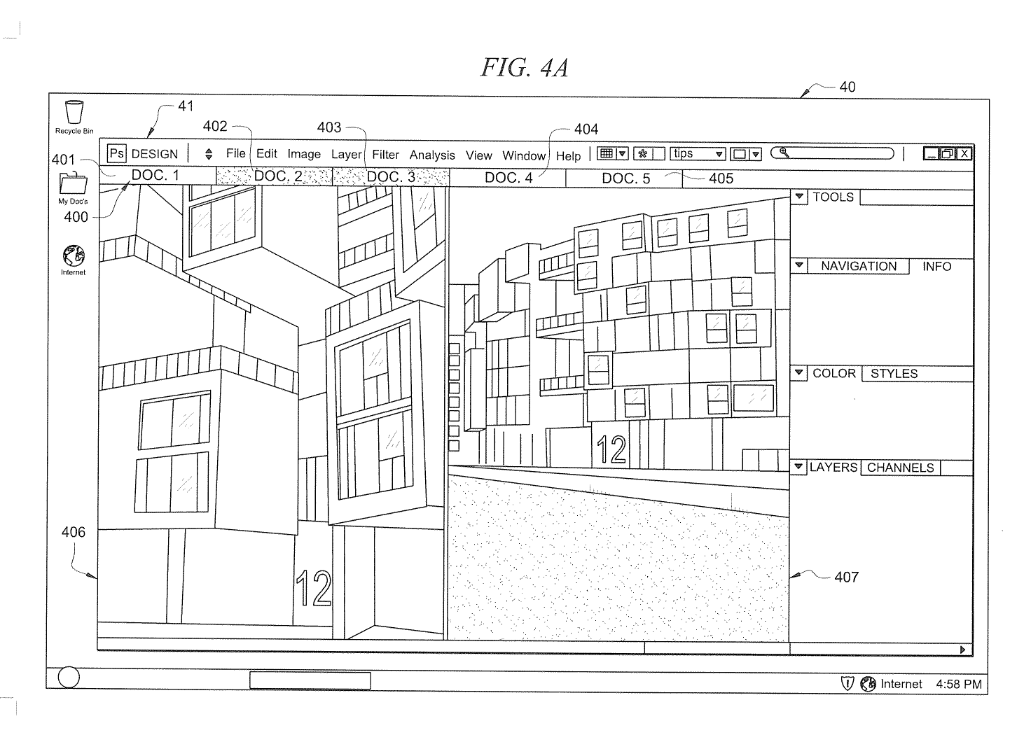

Turning to FIG. 3, an operational flow of a software application for managing presentation of opened documents according to one embodiment of the present invention is shown. In operational block 31, the software application presents to a display an interface (e.g., interface 200 of FIG. 2) that comprises a plurality of user-selectable elements (e.g., elements 201-204 of FIG. 2) that each corresponds to a respective one of a plurality of open documents (e.g., open documents Doc. 1-Doc. 4 of FIG. 2). As indicated in optional sub-block 301 in this exemplary embodiment, such interface may be presented responsive to the plurality of documents being opened in the software application. For instance, when only one document is opened in the software application, the exemplary tabbed-interface 200 of FIG. 2 may be unnecessary and thus not presented, but once a plurality of documents are detected by the application as being opened therein, the application may present such interface 200.

In operational block 32, the software application receives concurrent selection of a plurality of the elements. For instance, in the illustrated example of FIG. 2, concurrent selection of elements 202 and 203 is received. As discussed above, such concurrent selection of the plurality of elements may be made in any number of ways, such as by a user holding shift and clicking on a desired contiguous range of elements to be selected or by a user holding control and clicking on desired elements to be selected (which may or may not be a contiguous range of elements), as examples.

Responsive to the received concurrent selection, the software application concurrently displays the respective plurality of documents to which the selected elements correspond, in operational block 33. To concurrently display such plurality of documents, the software application may perform various operations to determine an appropriate arrangement of the plurality of documents on the display. Thus, as indicated in optional sub-block 302 in this exemplary embodiment, the software application may determine an arrangement of the plurality of documents to be presented on the display for optimally presenting the content of the documents. As an example, the software application may determine a size of each document window in operational block 303, and the software application may determine placement of each document window on the display in operational block 304. Further, the software application may, in operational block 305, determine presentation of document content for each document window being concurrently displayed. For instance, whether to size the presentation of content of a document to fit in its respective window, whether to crop the presentation of content for its respective window, whether to organize the presentation of the content in a portrait, landscape, or other orientation within its respective window, and/or other formatting of the document's content presentation may be determined in block 305.

According to one exemplary embodiment, the determination of an optimal arrangement of the concurrently selected documents may be based on at least two factors: 1) the document dimensions, and 2) the available screen real-estate to view the selected documents. The application may arrange the multiple documents in such a way to maximize the viewable area of the documents. It may determine this by calculating each of the orientations to figure out for the given document dimensions, which layout would maximize the viewable area for the multiple documents. For example, the application may show 2 rows for 2 selected landscape format documents, whereas it may show 2 columns if the 2 portrait format documents were concurrently selected.

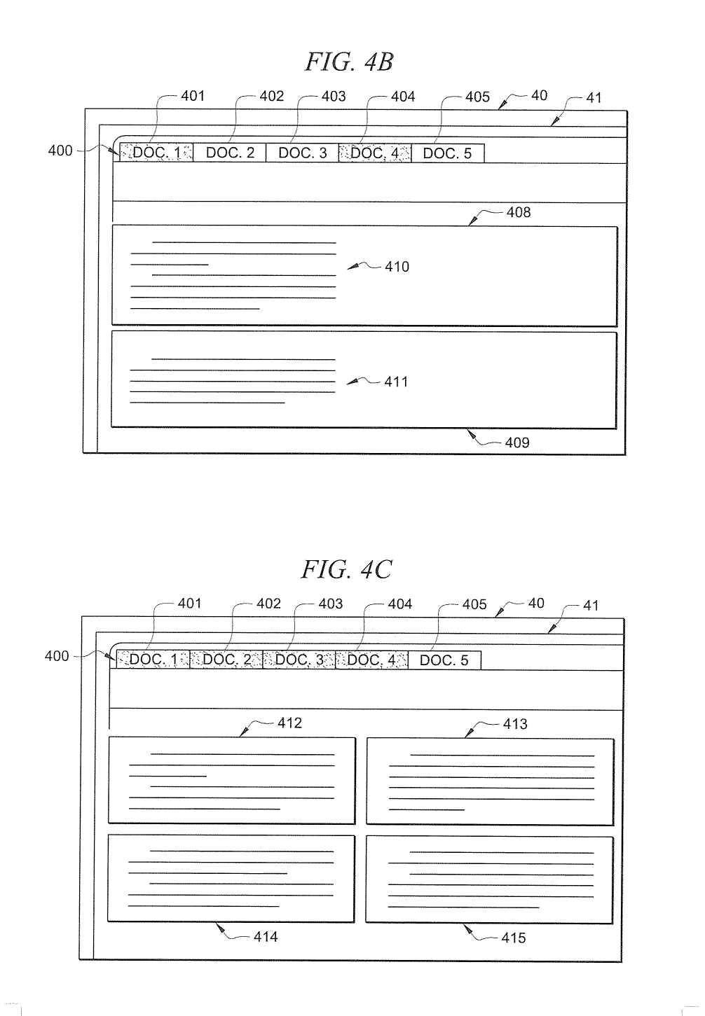

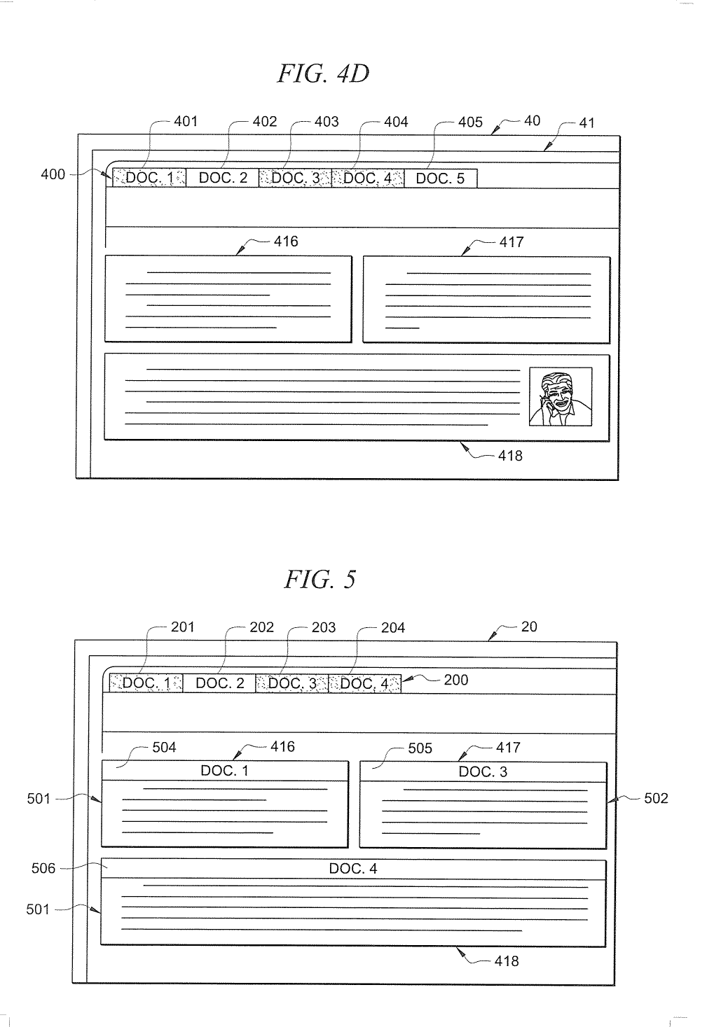

Turning now to FIGS. 4A-4D, exemplary arrangements of concurrently selected documents on a display that may be determined by the software application are shown for illustrative purposes. While these exemplary arrangements are shown to provide examples of the manner in which the software application may determine to arrange concurrently selected documents on a display, it should be appreciated that embodiments of the present invention are not limited solely to the exemplary arrangements shown but instead these are intended solely for illustrative purposes. In FIG. 4A, a display 40 is provided as part of a computing system on which a software application is executing. The software application presents to display 40 a display window 41, and thus in this example the display window 41 corresponds to the exemplary display 20 described above with FIG. 2, providing a soft-display in this instance. Further, the software application presents a user interface 400, in which elements (e.g., tabs) 401, 402, 403, 404, and 405 are presented, which correspond to open documents Doc. 1, Doc. 2, Doc. 3, Doc. 4, and Doc. 5, respectively, which are open within the software application. In the illustrated example of FIG. 4A, a user has concurrently selected elements 402 and 403 of interface 400, and in response to such selection the software application concurrently presents display windows 406 and 407 within the display window 41, wherein window 406 presents content of Doc. 2 (corresponding to element 402) and window 407 presents content of Doc. 3 (corresponding to element 403). In this example, the software application determines an arrangement of the windows 406 and 407 in which they are presented in a side-by-side fashion.

FIG. 4B shows another example in which display 40 is again provided, and a software application is again executing to present a display window 41 in which a user interface 400 is presented that includes elements (e.g., tabs) 401-405, as in the example of FIG. 4A discussed above. In this example, a user has concurrently selected elements 401 and 404 of interface 400, and in response to such selection the software application concurrently presents display windows 408 and 409 within the display window 41, wherein window 408 presents content 410 of Doc. 1 (corresponding to element 401) and window 409 presents content 411 of Doc. 4 (corresponding to element 404). In this example, the software application determines an arrangement of the windows 408 and 409 in which they are presented in a stacked fashion with window 408 arranged above window 409.

FIG. 4C shows another example in which display 40 is again provided, and a software application is again executing to present a display window 41 in which a user interface 400 is presented that includes elements (e.g., tabs) 401-405, as in the examples of FIGS. 4A-4B discussed above. In this example, a user has concurrently selected elements 401, 402, 403, and 404 of interface 400, and in response to such selection the software application concurrently presents display windows 412, 413, 414, and 415 within the display window 41, wherein window 412 presents content of Doc. 1 (corresponding to element 401), window 413 presents content of Doc. 2 (corresponding to element 402), window 414 presents content of Doc. 3 (corresponding to element 403), and window 414 presents content of Doc. 4 (corresponding to element 404). In this example, the software application determines an arrangement of the windows 412-415, in which the windows are arranged in a grid pattern (side-by-side stacked arrangement of two rows and two columns) with each window being sized equally.

FIG. 4D shows yet another example in which display 40 is again provided, and a software application is again executing to present a display window 41 in which a user interface 400 is presented that includes elements (e.g., tabs) 401-405, as in the examples of FIGS. 4A-4C discussed above. In this example, a user has concurrently selected elements 401, 403, and 404 of interface 400, and in response to such selection the software application concurrently presents display windows 416, 417, and 418 within the display window 41, wherein window 416 presents content of Doc. 1 (corresponding to element 401), window 417 presents content of Doc. 3 (corresponding to element 403), and window 418 presents content of Doc. 4 (corresponding to element 404). In this example, the software application determines an arrangement of the windows 416-418, in which the windows are arranged with windows 416 and 417 being side-by-side and stacked over window 418. Thus, in this example each window is not sized equally, but rather window 418 is wider than windows 416 and 417.

In certain embodiments, the software application may present identifying information to a user to aid the user in recognizing to which open document each of the plurality of concurrently presented windows corresponds. FIG. 5 shows one example of such identifying information being presented for the concurrently displayed windows. As with the example of FIG. 2 described above, FIG. 5 again shows display 20 on which a software application presents a user interface 200 that includes elements (e.g., tabs) 201-204 corresponding to open documents Doc. 1, Doc. 2, Doc. 3, and Doc. 4, respectively. In this example, a user has concurrently selected elements 201, 203, and 204 of interface 200, and in response to such selection the software application concurrently presents display windows 501, 502, and 503, wherein window 501 presents content of Doc. 1 (corresponding to element 201), window 502 presents content of Doc. 3 (corresponding to element 203), and window 503 presents content of Doc. 4 (corresponding to element 204). In this example, the software application presents title bars 504, 505, and 506 on windows 501-503, respectively, wherein each title bar presents identifying information, such as the document name, for the corresponding document whose content is presented therein. Of course, other techniques for presenting such identifying information may be provided in other embodiments. For instance, in one embodiment, in response to a user floating a cursor over a given window (or clicking on the window), the software application may present information (e.g., in a pop-up thumbnail adjacent the cursor) identifying information for document whose content is presented in the corresponding window (such as the document name).

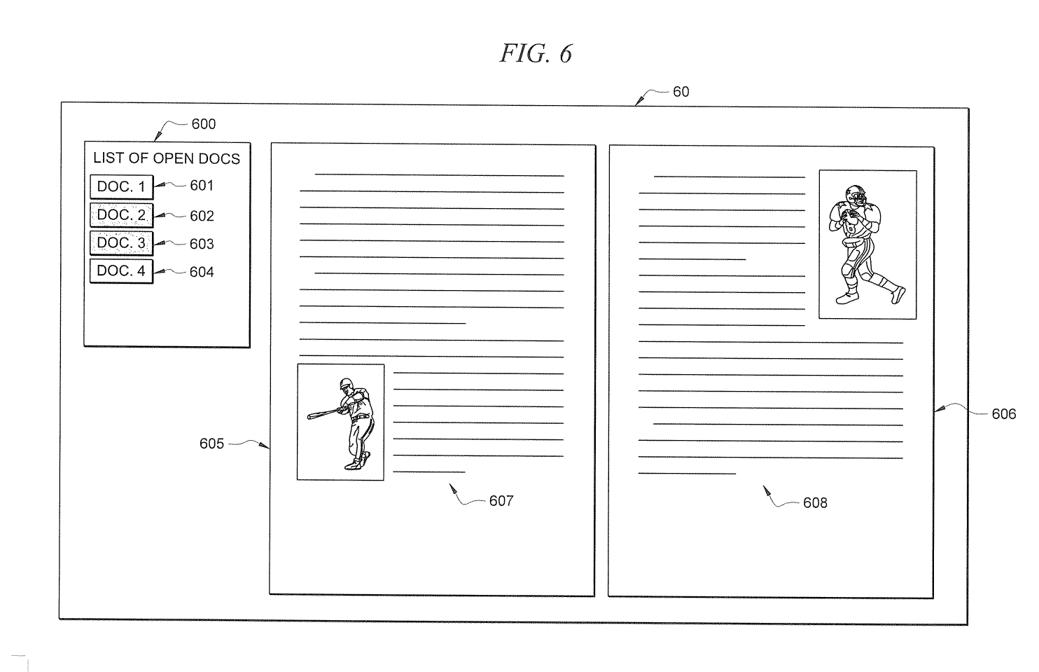

While tabs are shown as exemplary user-selectable elements in the above-illustrated examples of interfaces 200 and 400 of FIGS. 2, 4A-4D, and 5, other user-interface elements may be presented in other embodiments. For instance, FIG. 6 shows an exemplary user interface 600 according to one embodiment of the present invention. A display 60 is shown, which may be a full screen of a display device or a soft display (e.g., a containing window of an application), and a software application presents a user interface 600 on such display 60. Interface 600 includes elements 601, 602, 603, and 604 that correspond to open documents Doc. 1, Doc. 2, Doc. 3, and Doc. 4, respectively. In this example, the elements 601-604 are text items in a list that each identify a corresponding open document. Further, the interface 600 enables a user to concurrently select a plurality of such elements 601-604, and in the illustrated example the user has concurrently selected elements 602 and 603. In response to such concurrent selection, the software application concurrently presents windows 605 and 606, wherein window 605 contains content 607 of Doc. 2 (corresponding to selected element 602) and window 606 contains content 608 of Doc. 3 (corresponding to selected element 603).

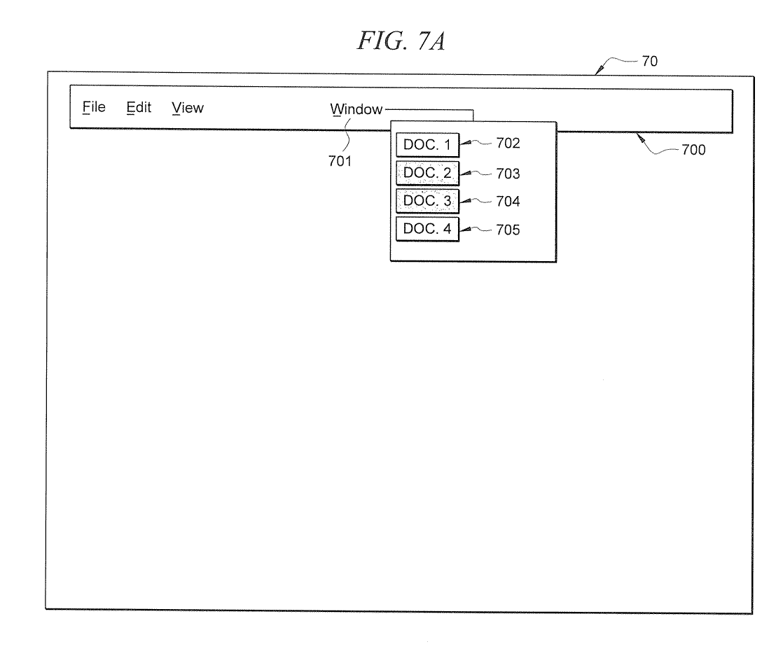

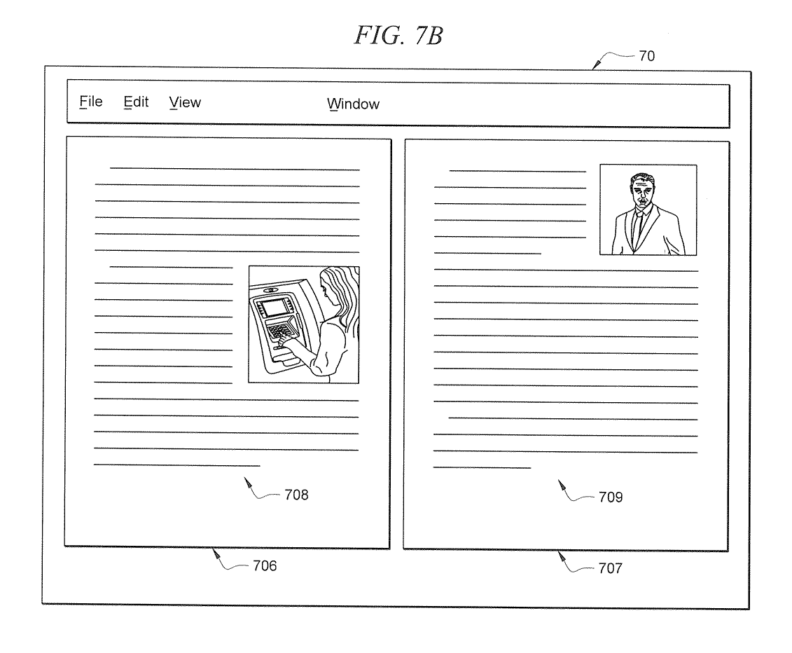

Further, while the exemplary interfaces 200, 400, and 600 of FIGS. 2, 4A-4D, 5, and 6 discussed above provide immediately-accessible elements, in other embodiments, the elements may not be immediately accessible, but may instead be embedded in a menu (e.g., in a pull-down menu from the title bar, a menu presented responsive to a right-click from the user or other user input, etc.). For instance, FIGS. 7A-7B show an exemplary user interface in which the elements are not immediately accessible via the display according to one embodiment of the present invention. A display 70 is shown, which may be a full screen of a display device or a soft display (e.g., a containing window of an application), and a software application presents a menu bar 700 that may include various immediately-accessible menu items (or root menu items), such as File, Edit, View, and the Window menu item 701. In this example, in response to a user selecting the Window menu item 701, a drop-down menu is presented that presents display elements 702, 703, 704, and 705 that correspond to open documents Doc. 1, Doc. 2, Doc. 3, and Doc. 4, respectively. In this example, the elements 702-705 are text items in a list that each identify a corresponding open document. Further, the drop-down menu interface enables a user to concurrently select a plurality of such elements 702-705, and in the illustrated example the user has concurrently selected elements 703 and 705. In response to such concurrent selection, the software application concurrently presents windows 706 and 707, as shown in FIG. 7B, wherein window 706 contains content 708 of Doc. 2 (corresponding to selected element 703) and window 707 contains content 709 of Doc. 4 (corresponding to selected element 705).

When implemented via computer-executable instructions, various elements of embodiments of the present invention are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information.

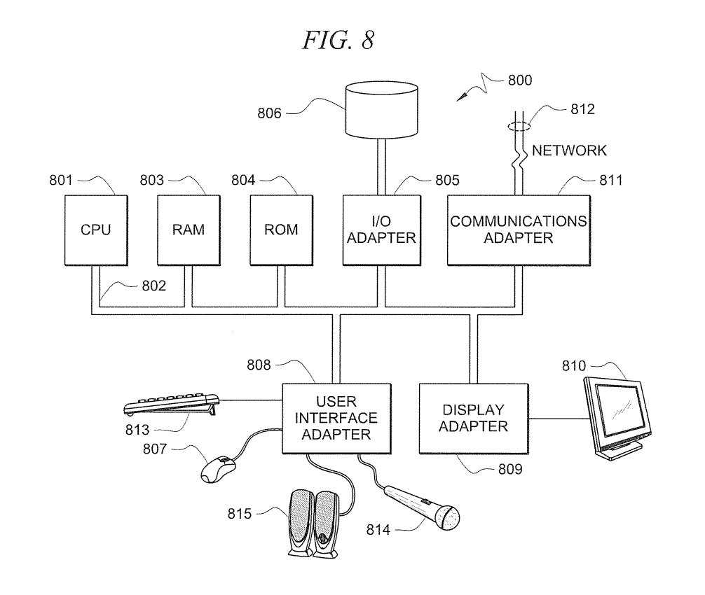

FIG. 8 illustrates an exemplary computer system 800 on which the software application for presenting a user interface that enables concurrent selection of multiple open documents and concurrently presents such concurrently selected documents in the manner discussed above may be implemented according to one embodiment of the present invention. Central processing unit (CPU) 801 is coupled to system bus 802. CPU 801 may be any general-purpose CPU. The present invention is not restricted by the architecture of CPU 801 (or other components of exemplary system 800) as long as CPU 801 (and other components of system 800) supports the inventive operations as described herein. CPU 801 may execute the various logical instructions according to embodiments of the present invention. For example, CPU 801 may execute machine-level instructions according to the exemplary operational flow described above in conjunction with FIG. 3.

Computer system 800 also preferably includes random access memory (RAM) 803, which may be SRAM, DRAM, SDRAM, or the like. Computer system 800 preferably includes read-only memory (ROM) 804 which may be PROM, EPROM, EEPROM, or the like. RAM 803 and ROM 804 hold user and system data and programs, as is well known in the art.

Computer system 800 also preferably includes input/output (I/O) adapter 805, communications adapter 811, user interface adapter 808, and display adapter 809. I/O adapter 805, user interface adapter 808, and/or communications adapter 811 may, in certain embodiments, enable a user to interact with computer system 800 in order to input information, such as for concurrently selecting a plurality of elements corresponding to open documents, as described above.

I/O adapter 805 preferably connects to storage device(s) 806, such as one or more of hard drive, compact disc (CD) drive, floppy disk drive, tape drive, etc. to computer system 800. Fhe storage devices may be utilized when RAM 803 is insufficient for the memory requirements associated with storing data for operations of the software application. Communications adapter 811 is preferably adapted to couple computer system 800 to network 812, which may enable information to be input to and/or output from system 800 via such network 812 (e.g., the Internet or other wide-area network, a local-area network, a public or private switched telephony network, a wireless network, any combination of the foregoing). User interface adapter 808 couples user input devices, such as keyboard 813, pointing device 807, and microphone 814 and/or output devices, such as speaker(s) 815 to computer system 800. Display adapter 809 is driven by CPU 801 to control the display on display device 810 to, for example, display the exemplary user interfaces and concurrently selected open documents, as described above.

It shall be appreciated that the present invention is not limited to the architecture of system 800. For example, any suitable processor-based device may be utilized for implementing embodiments of the present invention, including without limitation personal computers, laptop computers, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matters means, methods, or steps.

1. A method comprising:
presenting, by a software application, a user interface that includes a plurality of user-selectable elements, wherein each of the elements corresponds to a respective one of a plurality of open documents in the application;
enabling, by the software application, user selection of a plurality of the elements concurrently; and
responsive to receiving concurrent selection of said plurality of said elements, said software application concurrently displaying the respective plurality of documents to which the selected elements correspond.

2. The method of claim 1 wherein said plurality of user-selectable elements comprise tabs.

3. The method of claim 1 wherein said plurality of user-selectable elements comprise any of the following: tabs, textual list, and grid of thumbnails.

4. (canceled)

5. The method of claim 1 further comprising:
presenting said user interface that includes said plurality of user-selectable elements responsive to said plurality of documents being opened in the software application.

6. The method of claim 1 further comprising:
determining, by the software application, an arrangement on a display of said respective plurality of documents to which the concurrently selected elements correspond.

7. The method of claim 6 wherein said determining comprises:
determining an arrangement that enables concurrent viewing of said respective plurality of documents to which the concurrently selected elements correspond.

8. The method of claim 1 wherein said concurrently displaying comprises displaying each of the respective plurality of documents to which the concurrently selected elements correspond in a separate one of a plurality of windows.

9. The method of claim 8 further comprising:
determining, by the software application, an arrangement on a display of the plurality of windows in which the respective plurality of documents to which the concurrently selected elements correspond are presented.

10. The method of claim 9 wherein said determining comprises:
determining, for each of said plurality of windows, a respective window size.

11. The method of claim 10 wherein said determining comprises:
determining, for each of said plurality of windows, whether to modify the size of the content presented in a corresponding document presentation to fit in the window or to crop the corresponding document presentation.

12. The method of claim 1 wherein the enabling user selection comprises:
enabling, by the software application, user selection of a plurality of contiguous ones of the elements concurrently.

13. The method of claim 1 wherein the enabling user selection comprises:
enabling, by the software application, user selection of a plurality of noncontiguous ones of the elements concurrently.

14. A system comprising:
computer-readable medium to which a software application is stored;
processor operable to execute instructions of said software application;
display operable to display output of the software application;
input device operable to input information to the software application;
said software application operable to present on said display a plurality of user-selectable elements each corresponding to a respective one of a plurality of documents opened in the software application;
said software application operable to receive concurrent selection of a plurality of said elements, and responsive to said concurrent selection, concurrently output to the display the respective plurality of documents to which the concurrently selected elements correspond.

15. The system of claim 14 wherein said plurality of user-selectable elements comprise any of the following: tabs, textual list, grid of thumbnails, and graphical elements.

16. (canceled)

17. The system of claim 14 further comprising:
said software application operable to present said plurality of user-selectable elements responsive to said plurality of documents being opened in the software application.

18. The system of claim 14 further comprising:
the software application operable to determine an arrangement on the display of said respective plurality of documents to which the concurrently selected elements correspond.

19. The system of claim 18 wherein said software application is operable to determine said arrangement that enables concurrent viewing of said respective plurality of documents to which the concurrently selected elements correspond.

20. The system of claim 14 wherein said software application is operable to concurrently output to the display each of the respective plurality of documents to which the concurrently selected elements correspond in a separate one of a plurality of windows.

21. A method comprising:
responsive to a plurality of documents being opened in a software application, said software application presenting to a display an interface that comprises a plurality of user-selectable elements, wherein each of the plurality of elements included in the interface corresponds to a respective one of the plurality of open documents;
receiving, by the software application, user selection of a plurality of said elements concurrently; and
responsive to said receiving, the software application determining an arrangement on the display of said respective plurality of documents to which the concurrently selected elements correspond for optimally presenting on the display the content of the respective plurality of documents to which the concurrently selected elements correspond, and said application concurrently displaying on the display the determined arrangement of the respective plurality of documents to which the concurrently selected elements correspond.

22. The method of claim 21 wherein said plurality of user-selectable elements comprise any of the following: tabs, textual list, grid of thumbnails, and graphical elements.

23. (canceled)

24. Computer-executable software code stored to a non-transitory computer-readable medium that, when read by a processor-based computer, causes the computer to perform the method of:
presenting to a display a user-selectable tab interface that includes a plurality of user-selectable elements, wherein each of said plurality of elements corresponds to a respective one of a plurality of open documents in an application;
receiving user selection of a plurality of said elements concurrently; and
responsive to said receiving, said application concurrently displaying to the display the respective plurality of documents to which the concurrently selected elements correspond.

25. The computer-executable software code of claim 24 further comprising code that when read by the processor-based computer causes the computer to perform:
determining an arrangement on the display of said respective plurality of documents to which the concurrently selected elements correspond for optimally presenting on the display the content of the respective plurality of documents.

26. The method of claim 1, wherein said software application concurrently displays the respective plurality of documents to which the selected elements correspond directly in response to selection of said plurality of said elements.

27. The method of claim 1, wherein each of the plurality of documents comprises a different file being edited by said software application.
